(19) United States
(12) Patent Application Publication
(10) Pub. No.: US 2026/0170157 A1
(43) Pub. Date: Jun. 18, 2026

(54) DATA SPRAY TECHNIQUE TO IMPLEMENT FAULT RESISTANT DETECTION CIRCUITS

(71) Applicant: XILINX, INC., San Jose, CA (US)

(72) Inventors: Kenneth K. CHAN, San Jose, CA (US); Nathan A. BOLGER, San Jose, CA (US); Roger D. FLATEAU, JR., San Jose, CA (US); Sachchidanand Suhas DEO, Fremont, CA (US)

(21) Appl. No.: 18/986,541

(22) Filed: Dec. 18, 2024

(51) Int. Cl. G06F 21/60; G06F 13/40; G06F 21/79

(52) U.S. Cl. CPC G06F 21/606; G06F 13/4022; G06F 21/79

(57) ABSTRACT

Data spray techniques are used to implement fault resistant data detection using a plurality of data detectors. Each of the plurality of data detectors is coupled, at sequential times, to a lane of data bytes during transfers thereof from a data source to a data destination. Each data detector is individually associated with the lane of data bytes at sequential time slots representing each data byte transfer. All bits of the bytes being transferred on the lane are examined individually by the data detectors in determining if the data byte has been programmed for a security key code by detecting a certain logic state in at least one bit thereof. Associating each of the plurality of data detectors during data byte transfers improves security key detection by reducing the probability of a single defective data detector leading to an erroneous conclusion of the status of the data.

### TECHNICAL FIELD

Embodiments of the present disclosure generally relate to bit detection in adjacent parallel data lanes, and in particular, to using multiple data detectors on the adjacent pieces of data on the data lanes to lower the probability that a single data detector failure will lead to an erroneous conclusion of a data state of a security key.

### BACKGROUND

Referring to FIG. 1, depicted is a prior art schematic diagram of data detectors coupled to and monitoring a plurality of data lanes between data sources and destinations. In a digital system where information is sent from a data source 102 to a data destination 106 over two or more parallel data lanes of equal width, many designs deploy data detectors 104 per-lane located near the data destination 106 to glean information from the data being transferred. For example, security keys are transferred between source and destination on one or more lanes, over many consecutive transfers of chunks (bytes) in data words. During this transfer operation, a security processor, when notified by the data detector(s), determines that security keys have been programmed, and that the computer system or subsystem should be enabled to a higher level of security than if the computer system or subsystem has not yet been programmed with security keys. This is indicated by the presence of one or more ones (1s) in data from a lane used to transfer security keys over multiple data transfer cycles. If the “presence of 1s” detector has failed, then the intended high level of security would not be deployed. By applying multiple detectors on adjacent pieces of data on a lane, the probability that a single defective data detector will lead to an erroneous byte detection conclusion is reduced.

Another simple example is the use of byte-wide parity checkers at the end of a 4-byte wide data path (e.g., destination). When the association between a data detector 104 and the lane it serves is fixed (i.e., hardwired), a failure of a data detector 104 results in unchecked or unprotected data transferred. Since a failure mode may be data-dependent (e.g., odd vs even parity), a field failure may result in a large time gap between failure and detection thereof. By using multiple data detectors 104 per lane, each lane will get the benefit of having multiple sets of detector hardware that will provide more reliable detection results if a detector circuit should fail. However, this is expense, and requires additional operating power and silicon real estate (space on semiconductor die(s). Some other solutions involve periodically injecting known check patterns into the data stream at the source then checking and extracting the injected data at the destination. This takes away some data path bandwidth, and may involve control complexities.

### SUMMARY

In one example of the disclosure, a method for detecting logic states of bits in data bytes includes reading, by a plurality of data detectors, bits of respective data bytes transferred on at least one data lane between a data source and a data destination. Checking the read bits for a first logic state, wherein a bit read from a first data byte is checked with a data detector different from a data detector used to check a bit read from a previously transferred data byte on a same data lane. Indicating when the first logic state is detected in any of the read bits.

In one example of the disclosure, an apparatus for detecting logic states of bits in data bytes during transfers thereof includes a data source adapted for providing a plurality of bytes of data. A data destination adapted for receiving and storing the plurality of bytes being transferred from the data source over at least one data lane. A plurality of multiplexers having inputs coupled to the at least one data lane and outputs selectably coupled to the inputs thereof. A plurality of data detectors having inputs coupled to the outputs of the plurality of multiplexers, wherein the plurality of multiplexers are adapted for coupling the at least one data lane to the inputs of each of the plurality of data detectors. A spray multiplexer controller coupled to the plurality of multiplexers for controlling which ones of the plurality of data detectors are coupled to the at least one data lane. A data detector controller coupled to the plurality of data detectors for configuring each of the plurality of data detectors for reading bits of respective bytes being transferred, wherein each of the bytes being transferred is checked with a data detector different from the data detector used to check a previously transferred byte on a same data lane. A detected data processor coupled to the outputs of the plurality of data detectors representing bit state status of the bytes being transferred between the data source and the data destination, wherein the detected data processor outputs a first signal if bits of the byte are detected at expected logic states during transfers of the bytes to the data destination and a second signal if a bit of the bytes detected is not at the expected logic states during transfers of the bytes to the data destination.

In one example of the disclosure, an apparatus for detecting when a security key is programmed in a computer system includes a data source adapted for providing a plurality of security key bytes comprising at least one security key. A data destination adapted for receiving and storing the plurality of security key bytes being transferred from the data source over at least one data lane. A switch matrix having inputs coupled to the at least one data lane and outputs selectably coupled to the inputs thereof. A plurality of data detectors having inputs coupled to the outputs of the switch matrix, wherein the switch matrix is adapted for coupling the at least one data lane to the inputs of each of the plurality of data detectors. A switch matrix controller coupled to the switch matrix for controlling which ones of the plurality of data detectors are coupled to the at least one data lane. A data detector controller coupled to the plurality of data detectors for configuring each of the plurality of data detectors for checking at least one bit of respective security key bytes being transferred for a first logic state, wherein each of the security key bytes being transferred is checked with a data detector different from the data detector used to check a previously transferred security key byte on a same data lane. A security processor coupled to the outputs of the plurality of data detectors representing bit state status of the security key bytes being transferred between the data source and the data destination, wherein the security processor outputs a high security control signal if a bit is detected at the first logic state during transfers of the security key bytes to the data destination and a low security control signal when no bit is detected at the first logic state after transfers of the security key bytes to the data destination are finished.

### BRIEF DESCRIPTION OF THE DRAWINGS

So that the manner in which the above recited features of the present invention can be understood in detail, a more particular description of the invention, briefly summarized above, may be had by reference to examples, some of which are illustrated in the appended drawings. It is to be noted, however, that the appended drawings illustrate only typical examples of this invention and are therefore not to be considered limiting of its scope, for the invention may admit to other equally effective examples.

FIG. 1 illustrates a prior art schematic diagram of data detectors coupled to and monitoring a plurality of data lanes between data sources and destinations.

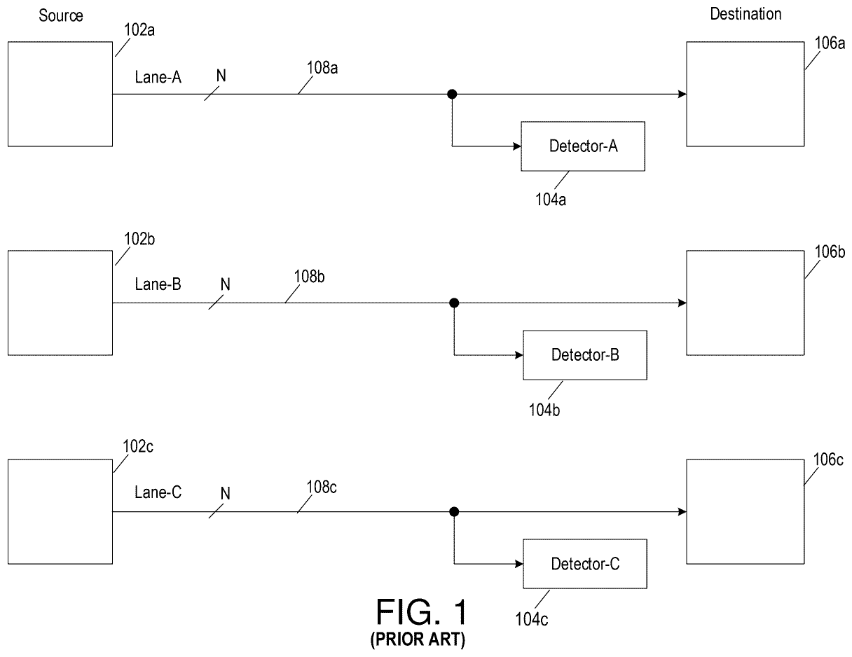

FIG. 2 illustrates a representative schematic diagram of data detectors coupled to and monitoring a plurality of data lanes between data sources and destinations with periodic swapping of the data detectors monitoring the data arriving at the data destinations, according to an example.

FIG. 3 illustrates a representative simplified schematic diagram of pairs of data detectors coupled to and monitoring pairs of data lanes between data sources and destinations with periodic swapping of the data detectors monitoring the data arriving at the data destinations, according to an example.

FIG. 4 illustrates a representative schematic block diagram of a data transfer system using data detectors for checking data on data lanes to detect and store states of data, according to an example.

FIG. 5 illustrates a representative schematic logic diagram of a plurality of data detectors, according to an example.

FIG. 6 illustrates a representative schematic logic diagram of a plurality of data detectors, according to another example.

FIG. 7 illustrates representative security key byte maps of a plurality of data byte/chunks, one per word, for two security key stripes, according to an example.

FIG. 7A illustrates representative security key byte maps of a plurality of data byte/chunks, in a plurality of words, for one security key stripe, according to an example.

FIG. 8 illustrates representative security key byte maps of a plurality of data byte/chunks, two per word, for two security key stripes, according to an example.

FIG. 9 illustrates a schematic process flow diagram of a plurality of data detectors checking a plurality of security key data bytes being transferred over at least one data lane of a computer system for a bit having a first logic state indicating a user programmed security key, according to an example.

To facilitate understanding, identical reference numerals have been used, where possible, to designate identical elements that are common to the figures, and a lower-case letter added where the elements are substantially the same. It is contemplated that elements of one embodiment may be beneficially incorporated in other embodiments.

### DETAILED DESCRIPTION

Various features are described hereinafter with reference to the drawing figures. It should be noted that the drawing figures may or may not be drawn to scale and that the elements of similar structures or functions are represented by like reference numerals throughout the drawing figures. It should be noted that the drawing figures are only intended to facilitate the description of the features of the examples. They are not intended as an exhaustive description of the examples below or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described. Referring now to the drawing figures, the details of examples are representative layouts schematically illustrated. Like elements in the drawing figures will be represented by like numbers, and similar elements will be represented by like numbers with a different lower-case letter suffix.

For discussion purposes hereinafter a data word may be 32 bits and comprise four bytes, each 8 bits. Bytes and “data chunks” may be used interchangeable herein. It is contemplated and with the scope of this disclosure that data words may also be more or less than 32 bits, and bytes or data chunks may be more or less than 8 bits. A “1” may represent a first or high digital logic state or level. A “0” may represent a second or low digital logic state or level. The examples disclosed herein may comprise words having more or less than four bytes or data chunks. One having ordinary skill in the digital electronic arts may adapt, having the benefit of this disclosure, what is described herein without deviating from the scope and intent of this description and what is being claimed in this disclosure.

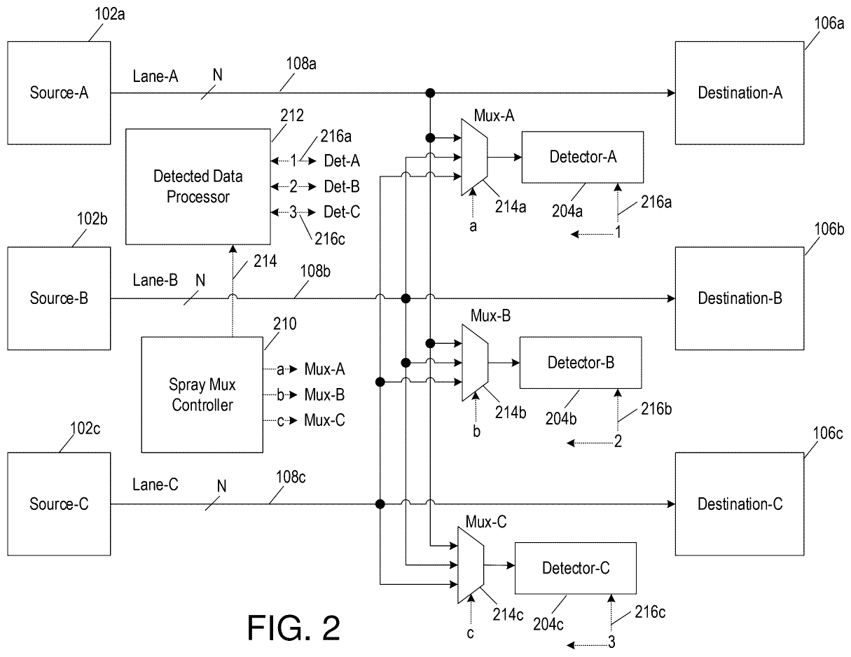

Referring to FIG. 2, depicted is a representative schematic diagram of data detectors coupled to and monitoring a plurality of data lanes between data sources and destinations with periodic swapping of the data detectors monitoring the data arriving at the data destinations, according to an example. By applying multiple detectors on adjacent pieces of data on a lane, the probability is reduced that a single defective data detector will lead to an erroneous conclusion of the status of the data. This helps with the integrity of the data detectors (or alternatively data checkers), such that if one detector fails, another would act as a secondary detector at a different data checking slice in time.

For example, security keys are transferred between source and destination over one lane, having many consecutive byte/chunks during word transfers from a source to a destination. During this transfer operation, a security processor, using the results from the data detectors (checkers), determines that at least one security key has been programmed. Once a programmed security key has been detected, the security processor will enable a higher level of security than when no security keys have been found to be programmed. This is indicated by the presence (detection) of one or more “1”s in the security key lane over the multiple word transfer cycles. If a “presence of 1s” detector has failed, then the intended high level of security would not be deployed. By allowing multiple detectors in multiple lanes to perform the 1's checking according to the teachings of this disclosure, a single failed data detector would be much less likely to allow a lower level of security than intended. This is probabilistic and not absolutely conclusive, but with different data detectors sampling for “1s” in enough security key chunks, a programmed security key will be detected.

Without resorting to multiple data detectors operating simultaneously on each data lane at each data destination may be accomplished efficiently and inexpensively by swapping data detectors 204 between different data lanes after each data word transfer, e.g., associating different data detectors 204 with a data lane or lanes 108 over time. By using different data detectors 204 per lane sequentially (re-associating detectors with a data lane(s) 108, each data lane 108 will get the benefit of having more than one set of data detector hardware examining data words for each lane without requiring additional redundant data detectors 204. A failed data detector 204 may not be absolutely identifiable, but by using the results of different data detectors 204 the combined result is more probabilistically correct.

A data multiplexer 214 may couple one data lane 108 and an associated data detector 204. The data multiplexer 214 inputs and outputs may be N-bits wide to match the data lane 108 N-bit width. However, it is contemplated and within the scope of this disclosure that not all bits in a data lane 108 need be checked, depending upon what is being checked. Swapping or rotation of the data detectors 204 between the data lanes A, B, C may be accomplished using data multiplexers 214 and a spray multiplexer controller 210. The spray multiplexer controller 210 controls each data multiplexer 214 to select a different data detector 204 for coupling to each data lane 108. So that no two data detectors 204 are coupled to the same data lane 108 at the same time. Rather each data detector 204 is rotated through and/or randomly selected (swapped) for association with a unique data lane 108 during the transfer of a data word. The spray multiplexer controller 210 may use sequencers or random number generators in determining unique selections of the data detectors 204 for each data lane 108. The random number generators may be, for example but are not limited to, a linear-feedback shift register (LSFR).

An example table of selection combinations of FIG. 2 are as follows:

| | | | | | | |
|---|---|---|---|---|---|---|
| Lane A | Det. A | Det. B | Det. C | Det. C | Det. A | Det. B |
| Lane B | Det. B | Det. C | Det. A | Det. B | Det. C | Det. A |
| Lane C | Det. C | Det. A | Det. B | Det. A | Det. B | Det. C |

These combinations may be sequentially or randomly selected. However, changing of the associations of data detectors 204 with data lanes 208 may only be done on data chunk boundaries (completion of a word transfer from data source to data destination).

A detected data processor 212 may receive detected data information from each of the data detectors 204 associated with chunks (bytes) of a data word. As shown in FIG. 2, each data lane 108 transfers a byte/chunk of a word from the data source 102 to the data destination 106. Each byte/chunk is N bits wide and there are three data lanes shown in FIG. 2 that simultaneously (synchronously) transfer three bytes/chunks comprising a word at a time. Thus, each word may be transferred at each data transfer cycle or clock (in three synchronous data bytes/chunks). However, if the checking needs to be computed over multiple chunks (transferred on the same lane) where there is much partial state information from the computation to be passed between chunks, then the detectors should change/swap only on chunk boundaries where the required passing of state information between detectors is zero or minimal. This may be every two clocks, four clocks or even at data structure boundaries. This is all kept track of by the detected data processor 212 as is the detected output formats from the data detectors 204. Data detection characteristics may also be sent from the detected data processor 212 to each of the data detectors 204 for processing of the snooped data on each of the data lanes 108, e.g., whether the data is of interest as part of a security key or parity check.

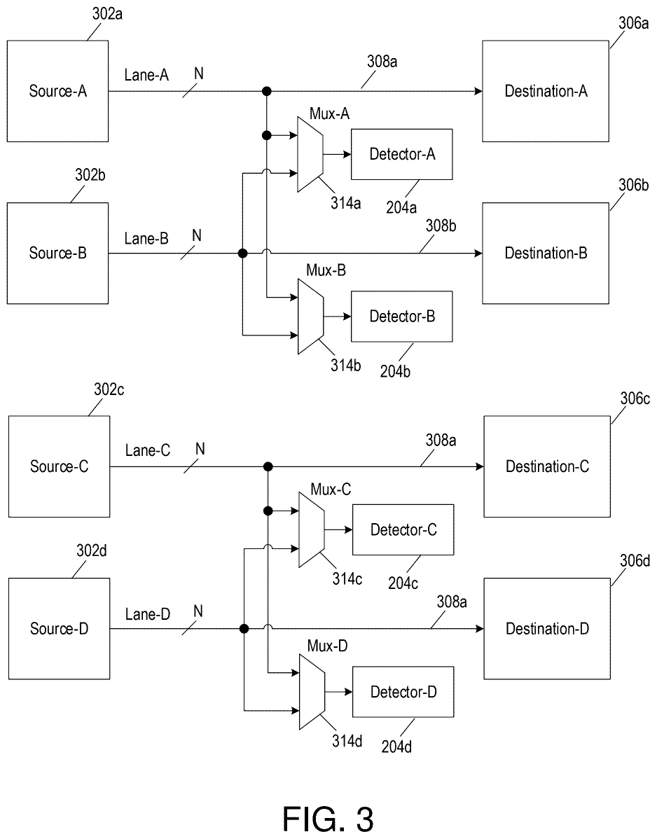

Referring to FIG. 3, depicted is a representative simplified schematic diagram of pairs of data detectors coupled to and monitoring pairs of data lanes between data sources and destinations with periodic swapping of the data detectors monitoring the data arriving at the data destinations, according to an example. Applying alternate detectors on adjacent pieces of data on a lane, the probability is reduced that a single defective data detector will lead to an erroneous conclusion of the status of the data. This helps with the integrity of the data detectors (or alternatively data checkers), such that if one detector fails, the other will act as a secondary detector at a different data checking slice in time. Using the alternate data detectors 204 per lane sequentially, each data lane 308 will get the benefit of having two different sets of data detector hardware examining data words for each data lane 308 without requiring additional redundant data detectors 204. Reducing the number of alternate data detectors 204 (this example limits two per lane rather than normally as many alternates as there are lanes), simplifies the spray controller design, reduces the number of inputs to each of the data multiplexers 314 (to two), and lowers the wiring required between the many data lanes 308 and each of the multiplexer inputs, all without sacrificing the benefit of having a secondary data detector for each data lane 308.

Pairs of data multiplexers 314 are coupled between pairs of data lanes A, B, C, D and inputs of associated pairs of data detectors 204. The data multiplexer 314 inputs and output are N-bits wide to match the Lane N-bit width. Swapping of the data detectors 204 between the data lanes A and B, and C and D may be accomplished using pairs of data multiplexers 314 and a spray multiplexer controller 210 (see FIG. 2). The pair of data multiplexers 314 alternately select a different data detector 204 at a time for each data lane pair after completion of a data word transfer. So that no two data detectors 204 are coupled to the same data lane 308 at the same time. Rather each data detector 204 is swapped between two unique data lanes 308 of a pair after a transfer of a data word. The spray multiplexer controller 210 may use sequencers or random number generators in determining frequency of selection swapping of the data detectors 204 for each data lane. The random number generators may be, for example but are not limited to, a linear-feedback shift register (LSFR).

A table of the selection combinations of FIG. 3 are as follows:

| | | |
|---|---|---|
| Lane A | Det. A | Det. B |
| Lane B | Det. B | Det. A |
| Lane C | Det. C | Det. D |
| Lane D | Det. D | Det. C |

Changing of lane-detector associations may only be done synchronously on byte/chunk boundaries (completion of word transfers).

A detected data processor 212 (FIG. 2) receives detected data information from each of the data detectors 204 associated with a chunk of a data word. As shown in FIG. 3, each data lane transfers a byte/chunk of a word from the data source 302 to the data destination 306. Each byte/chunk is N bits wide and there are four data lanes that simultaneously (synchronously) transfer four byte/chunks of data comprising a word. Thus, each word may be transferred at each data transfer cycle or clock, e.g., in four chunks. Not all the byte/chunks of a word may be required for the security key. However, more than one word transfer may be needed if a partial result (state) must pass between detectors when the check-computation cannot be completed within a chunk. Thus, if there are more byte/chunks than data lanes then two or more clocks for (data) transfers are required. This is all kept track of by the detected data processor 212 (FIG. 2) as is the detected output formats from the detectors 304. Data detection characteristics may also be sent from the detected data processor 212 (FIG. 2) to each of the data detectors 204 for processing of the snooped data on each of the lanes.

The detected data processor 212 knows which data lane 308 is coupled to which data detector 204 and can tell that data detector 204 what data to check for in that data chunk (byte) on that lane 308. For example, when checking whether security keys have been set by a user there will be a “1” somewhere in a byte or chunk of data in a data lane 308. If the detector 204 sees only zeroes, then security keys have not been programmed. A problem results if a data detector 204 is not working and fails to detect a 1 that is in a byte/chunk which may leave the security processor vulnerable or unprotected. But security key information is generally in more than one chunk/byte so another data detector 204 that is working will detect a 1 in a subsequent word transfer of that security key. This is an important advantage because even if one detector misses a one because it is defective or there were no “1s” in the byte/chunk at that transfer time slice, a different detector can detect a “1” when present in a subsequent data transfer. All bits in a byte may be examined for a one by using an N-input OR gate, and if a “1” is found then that state may be remembered in a memory, e.g., flip-flop. The bit position is not important, just that a “1” exists in the byte/chunk examined. The input of a memory flip-flop may also be controlled so that a byte being examined that is not relevant (of interest) to what is being checked for can be ignored. Similarly, parity bytes may be checked by the data detectors 204 that may be programmed to recognize the correct parity information.

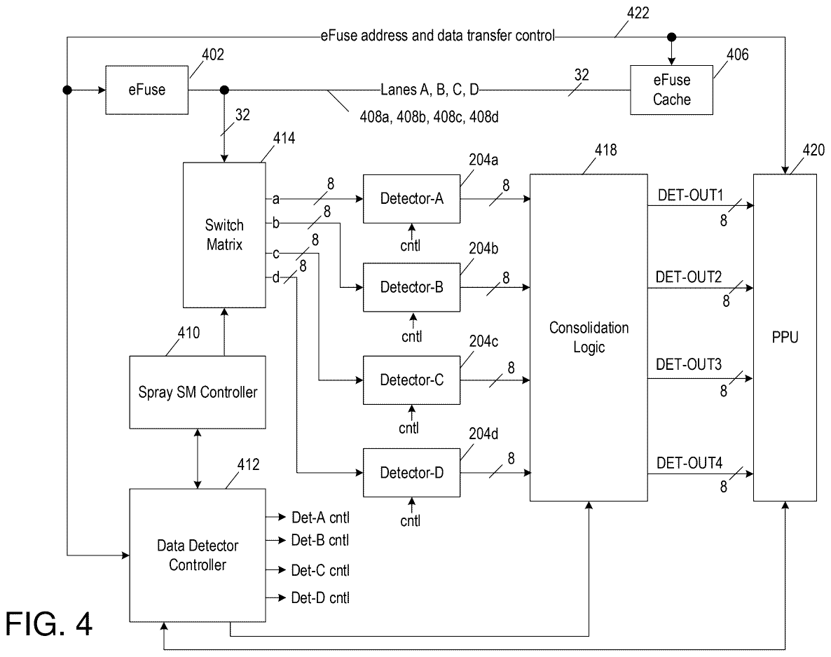

Referring to FIG. 4, depicted is a representative schematic block diagram of a data transfer system using data detectors for checking data on data lanes to detect and store states of data, according to an example. An eFuse 402 non-volatile memory may be the data source for security keys. An eFuse cache 406 may be the data destination for storing the security keys for use in the security processor 420. 32-bit data words containing the security keys may be sent over four lanes, each lane comprising a byte/chunk of eight (8) bits. It is contemplated and within the scope of this disclosure that the data words may be any number of bytes/chunks/bits in width. The data chunks may be any number of bits. The data words may be sent over any number of lanes, each lane comprising any number of bits.

For discussion purposes of the functions show in FIG. 4, without limiting the scope of this disclosure, a data word may be 32-bits, the data word may be sent over four data lanes A 408a, B 408b, C 408c, D 408d. Each data lane 408 may comprise one byte/chunk of 8 bits. A switch matrix 414 may have 32-inputs coupled to the four lanes comprising the bus between the eFuse 402 and the eFuse cache 406. The switch matrix 414 may have four groups of outputs, each group of outputs may be 8-bits. Each group of outputs from the switch matrix 414 may be coupled to a unique (different) one of the four data detectors 204. As shown in FIG. 4, the “a” group of outputs are coupled to the data detector-A 204a. The “b” group of outputs are coupled to the data detector-B 204b. The “c” group of outputs are coupled to the data detector-C 204c. And the “d” group of outputs are coupled to the data detector-D 204d.

The switch matrix 414 is adapted to couple the four data lanes 408a, 408b, 408c, 408d of 8-bit bytes/chunks comprising the 32-bit word to any unique combination of the data detectors 204 such that each data detector 204 is coupled to a different data lane 308, i.e., only one lane may be coupled to one data detector 204 at a time. A spray switch matrix controller 410 may instruct the switch matrix 414 to change the data detectors' 204 associated with the data lanes 308, e.g., swap, shuffle, rotate, interchange, each data detector to a different data lane after each 32-bit word transfer. However, when a security key stripe comprises a plurality of byte/chunks, a plurality of data word transfers will be required. The security key data detector associations with the data lane(s) 308 are changed on a per-byte/chunk basis, e.g., every actual word data transfer cycle.

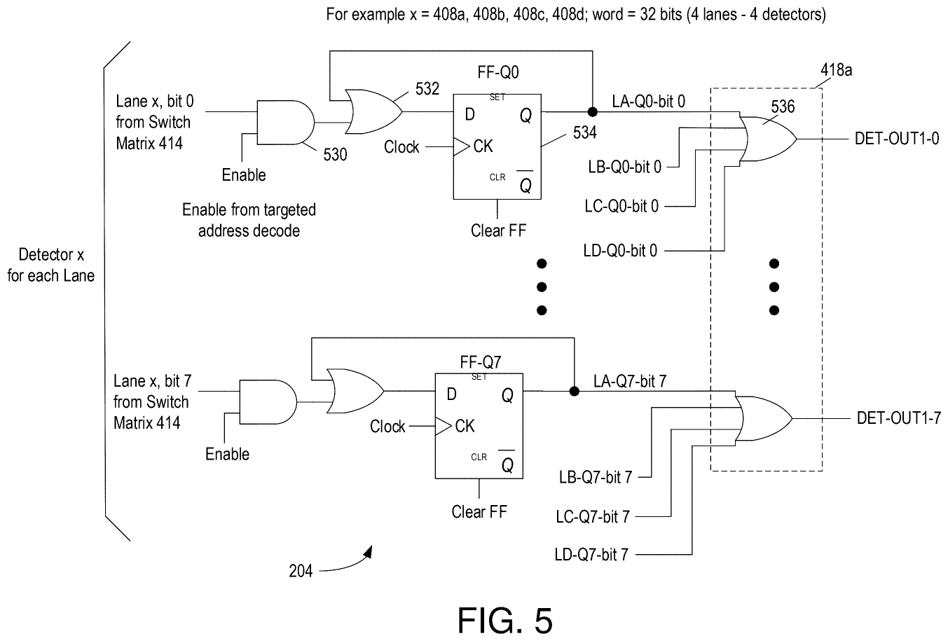

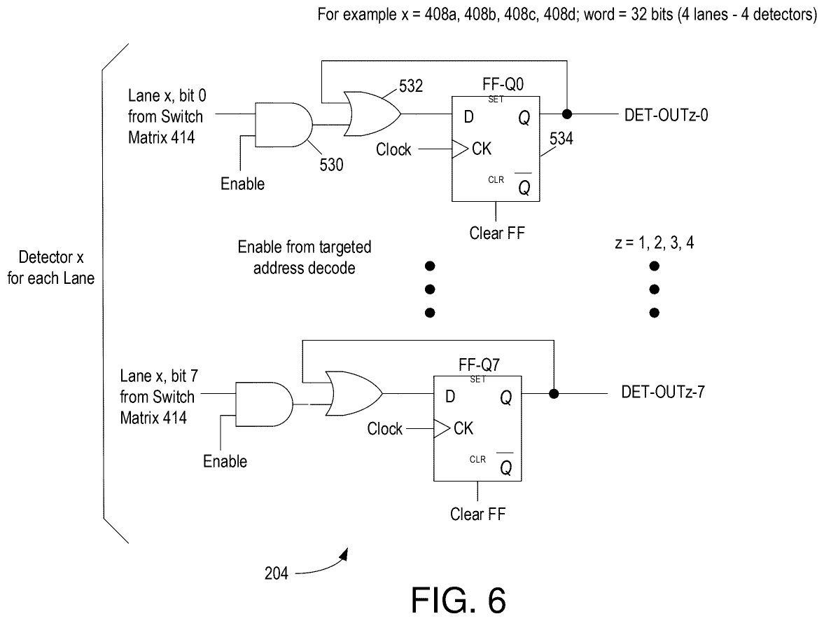

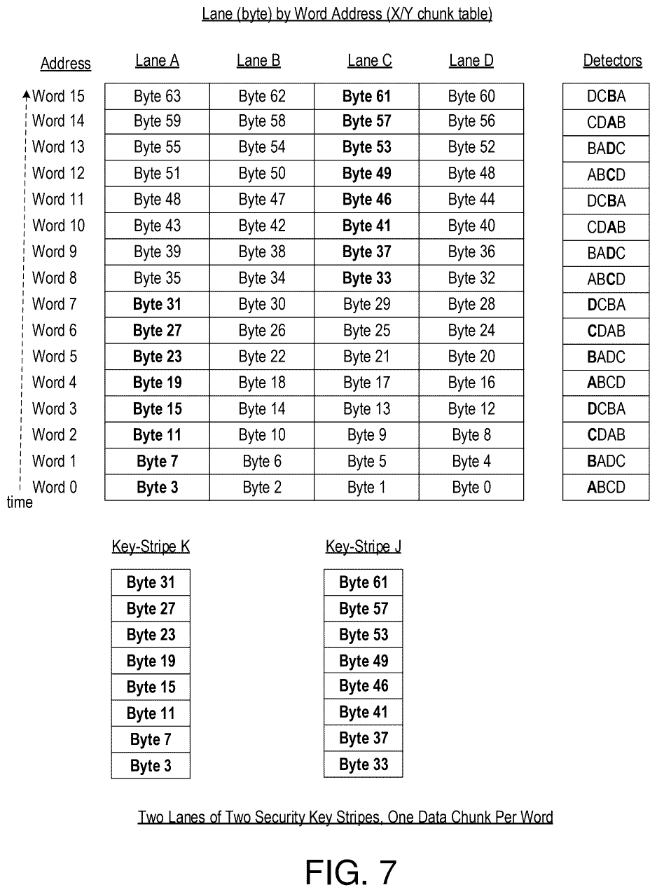

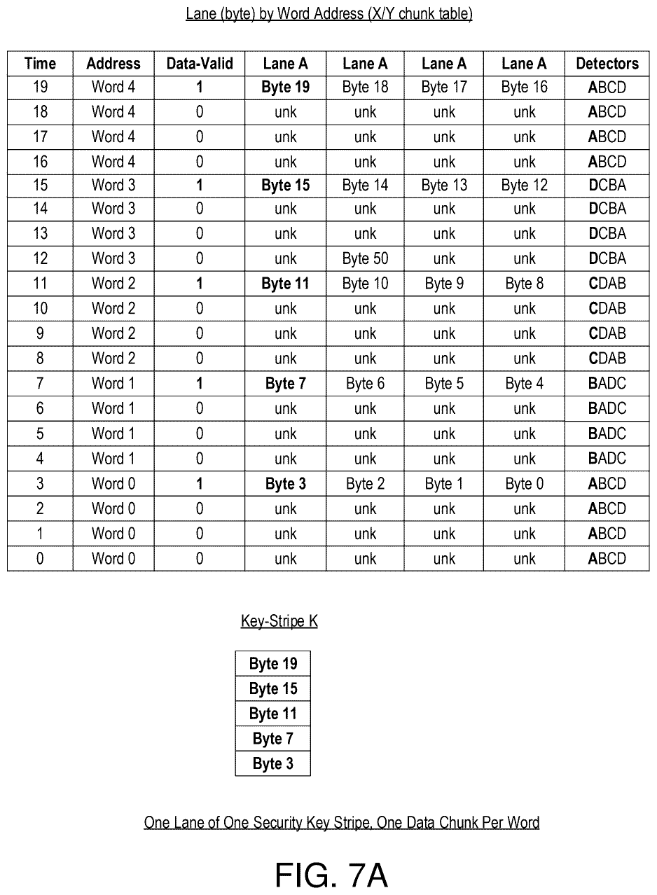

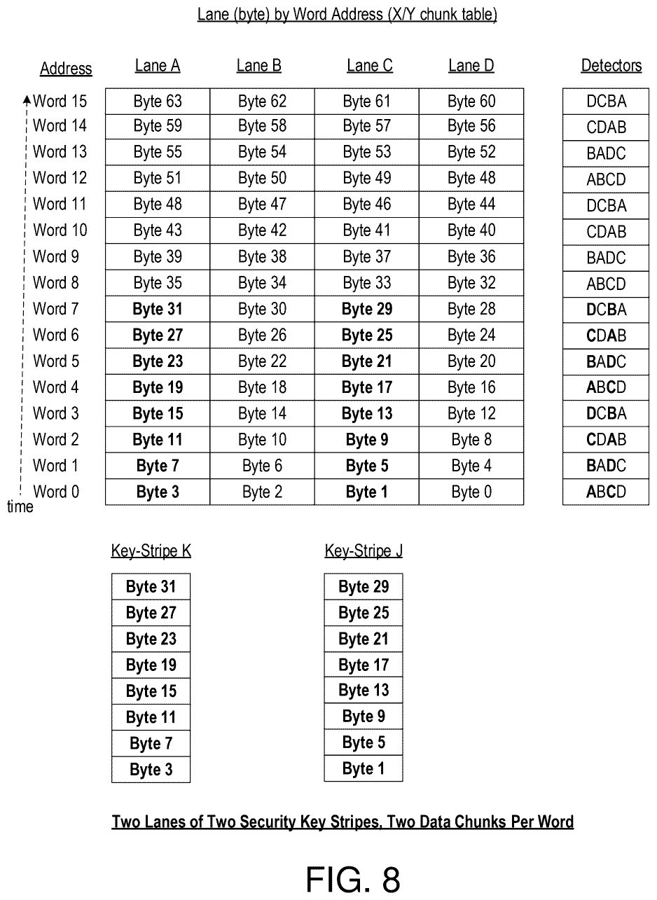

Each data detector 204 may be programmed by the data detector controller 412 to evaluate a byte/chunk of interest at a time that the data word is being transferred between the eFuse 402 (data source) and the eFuse cache 406. For byte/chunks or lanes that are not of interest the associated data detectors 204 may be inhibited as more fully described hereinafter in the operation of the data detectors shown in FIGS. 5 and 6. Preferably, one lane will be used for transfer of security key byte/chunk data. However, it is contemplated and within the scope of this disclosure that more than one lane may be used to transfer more than one security key byte/chunk data sequentially and/or simultaneously as shown in FIGS. 7, 7A and 8 hereinafter.

The data detector controller 412 may also control logic configurations in the consolidation logic 418 depending on what bytes/chunks are to be examined (only those of interest) and what bits of the examined bytes/chunk will be considered in the data detection result. Each data detector 204 may be configured (programmed) to detect a logic “1” in any of the bit positions of the byte/chunk being examined, and/or used as a parity checker for its associated byte/chunk (an extra parity bit, e.g., a byte with parity comprises 9 bits). The data detector controller 412 may also monitor an eFuse address and data transfer control bus 422 in determining when to configure the data detectors 204 and which bytes/chunks on the data lanes 408 to examine (are of interest), described more fully hereinafter in the discussion the embodiment of FIG. 7A. The eFuse address and data transfer control bus 422 may include a “Data-Valid” signal which indicates when the eFuse 402 (data source) can transfer data onto the data lanes 408, and a “Ready” signal to indicate when the eFuse cache 406 (data destination) can accept data from the eFuse 402 (data source).

A security processor 420 may receive the detected data results from the data detectors coupled through the consolidation logic 418. The security processor 420 may receive a data detection result for one to four lanes bytes/chunks of data (words) being examined, e.g., one lane's byte detection result through DET-OUT1, two lane's byte detection results through DET-OUT1 and DET-OUT2, three lane's byte detection results through DET-OUT1, DET-OUT2 and DET-OUT3; and four lane's byte detection results through DET-OUT1, DET-OUT2, DET-OUT3 and DET-OUT4. It is contemplated and within the scope of this disclosure that each detection result can be represented by more or less than 8-bits. The number of detection results (DET-OUTx) is dependent upon the number of data detectors 204 available during a word examination. The data detector controller 412 and the security processor 420 are synchronized and aware of the data word address of each word being examined at the time of its transfer between the eFuse 402 (data source) and eFuse cache 406 (data destination). Thereby insuring proper setup and configurations of the data detectors 204 and consolidation logic 418 for each word transfer.

Referring to FIG. 5, depicted is a representative schematic logic diagram of a plurality of data detectors, according to an example. Each data detector 204 associated with a data lane 408 (total eight detectors) will examine the individual bits of a byte/chunk of a word during a data word transfer between the eFuse 402 (data source) and eFuse cache 406 (data destination), depending on whether the byte/chunk is of interest, e.g., may contain security key information or word parity. For this example, but is not limited to, a byte/chunk is 8-bits and each bit has a detection circuit comprising an AND-gate 530, an OR-gate 532 and a flip-flop 534 (FF). Each bit (of the 8-bit byte/chunk) from the byte/chunk associated with this detector 204 will be coupled to a first input of the AND-gate 530 (eight AND-gates 530, one for each bit of the byte/chunk) and a second input coupled to an enable from the data detector controller 412. An output of the AND-gate 530 will be coupled to a second input of the OR-gate 532. The data detector controller 412 will allow bits of byte/chunk information of interest (targeted address decode) to pass to the second input of the OR-gate 532 through the enabled AND-gate 530, all bits of byte/chunk information not of interest will be inhibited (to logic “0”) by the AND-gate 530. An output of the OR-gate 532 will be coupled to an input of the FF 534. An output of the flip-flop 534 will be coupled to a second input of the OR-gate 532. A clock (indicating a data word transfer operation between the eFuse 402 (data source) and the eFuse cache 406 is coupled to an input of the flip-flop 534. When a logic “1” is detected on a bit of the byte/chunk of interest and the clock is received at the clock input of the flip-flop 534, the flip-flop 534 will store and retain that logic “1” value on its output (Q) until cleared (reset). Preferably, the flip-flops 534 are reset upon power-on, and then after the data detectors 204 have snooped the byte/chunks of interest the values therein are read by a security processor 420 after the entire contents of eFuse 402 (data source) (security key(s) bytes/chunks source) has been transferred to eFuse cache 406 (security key(s) bytes/chunks destination. After reading for the presence of “1s” in the security byte/chunks of interest, the flip-flops 534 need not be cleared unless eFuse is to be re-read into the eFuse cache 406, e.g., upon computer power-up and again when reloading of the eFuse cache 406.

Each output of a flip-flop 534 associated with each bit (detected bit of interest) of a byte/chunk in a data lane 408 may be coupled to respective inputs of two four-input OR-gates 536, one input for each bit of a byte/chunk in a data lane 408. Whenever there is a “1” (one) in any bit of a byte/chunk of a lane being examined, a logic “1” will be stored in a respective flip-flop 534 and available at the output thereof. The output of each OR-gate 536 representing a bit of interest that has been examined may be coupled to the security processor 420. The logic circuit shown in FIG. 5 allows detection results for a single byte/chunk per word transfer of a lane from each data detector 204 (four) coupling only eight bits to the security processor 420 over the DET-OUT1 bus. (All data detector (8) bit detection results for one data lane 408). Only one lane of bytes/chunks may be examined at a time. However, it is contemplated and within the scope of this disclosure that byte/chunks of different lanes may be examined at different time slices, e.g., different transfer clock times, and/or simultaneously with different ones of the plurality of data detectors 204.

Referring to FIG. 6, depicted is a representative schematic logic diagram of a plurality of data detectors, according to another example. The data detectors 204 logic circuit shown in FIG. 6 functions in substantially the same as the data detectors 204 logic circuit shown in FIG. 5. The differences between the logic circuits of FIG. 5 and FIG. 6 are that all four data detectors may be used simultaneously to examine the bytes/chunks of all four lanes during a word transfer and convey the examination results thereof to the security processor 420 during a single data word transfer. The only additional requirements are four eight-bit detectors, one eight bit set of detectors for each lane, and four eight-bit outputs, DET-OUT1, DET-OUT2, DET-OUT3 and DET-OUT4 (FIG. 4) may be used, one for each simultaneous lane detection result. A flip-flop 534 storing a “1” from detection of a “1” in bit of any byte of a lane will carry over in subsequent snoops of the different lane bytes, but an object is to detect a “first 1” indicating that a security key has been programmed so as to alert the security processor 420 to increase computer security based upon a security key being programmed.

The detector logic circuits of FIG. 6 are four detector logic circuits of FIG. 5 that allow parallel pipelining of programmed security keys detection of the bytes/chunks of two or more security key stripes being transferred in at least two lanes per word. If data detection of all four lanes are not required, then just two or three lanes may be examined by processing the detected data from the DET-OUT1, DET-OUT2, DET-OUT3 and DET-OUT4 (FIG. 4) buses as required. The number of bits of each detection result can be further reduced from eight bits per lane to from four to one bit per lane by utilizing further combinatorial logic, e.g., an eight-input OR gate will result in a single bit output indicating that a security key byte has been programmed by a user. If only one lane is used for transfer of security keys, then the detector logic circuits of FIG. 5 will suffice.

The logic structures shown in FIGS. 4, 5 and 6 and described hereinabove allow detection of data in a byte/chunk indicating that a security key has been programmed by a user. During this detection process each data detector may be dynamically associated with different data lanes of a security key word to increase the probability of determining that a security key has been programmed, even if a data detector is defective. The data detector logic circuits of FIG. 6 may also be used for determining which data detector is defective by comparing the bit snoop results from DET-OUTz-0 . . . . DET-OUTz-7 (where z=1, 2, 3, 4) outputs. If these outputs never change then the data detector is probably defective.

The flexibility of being able to dynamically associate any data detector 204 with any data lane 408 without restriction except that each data detector and lane association must be unique, e.g., only one data detector is coupled to each lane at a time. This is important when searching word transfers from eFuse 402 to the eFuse cache 406 for programming of critical data structures (e.g., security keys) and to disable certain debug features, e.g., increasing computer security, if security keys have been found to be programmed. This searching may be implemented as snoops for 1's on critical data (e.g., security key bytes) as eFuse data is loaded from eFuse 402 (data source) to eFuse cache 406, with the data travelling in parallel over up to four byte-wide data lanes 408.

Referring to FIG. 7, depicted are representative security key byte maps of a plurality of data byte/chunks, one per word, for two security key stripes, according to an example. Two lanes transfer bytes for two security key stripes. Eight-byte security key stripes K and J may be transferred from the eFuse 402 (data source) to the eFuse cache 406 (data destination) in sixteen-word transfers (eight for key stripe K and eight for key strip J) and examined for security key programming by all four data detectors 204a-204d. Two security key stripes K and J may be assembled from bytes of each of the 16-word transfers and examined for security key programming by four different data detectors 204. The security key logic of FIG. 5 will suffice since only lane A is used during the transfer of words containing the bytes/chunks for the security key stripe K, and lane C is used during the transfer of words containing the bytes/chunks for the security key stripe J.

Referring to FIG. 7A, depicted are representative security key byte maps of a plurality of data byte/chunks, in a plurality of words, for one security key stripe, according to an example. One lane (A) transfers bytes for one security key stripe. An eight-byte security key stripe K may be transferred from the eFuse 402 (data source) to the eFuse cache 406 (data destination) in a plurality of word transfers (twenty shown for key stripe K) and examined for security key programming by all four data detectors 204a-204d. One security key stripe K may be assembled from bytes of some of the 20-word transfers shown in FIG. 7A and examined for security key programming by four different data detectors 204. The security key logic of FIG. 5 will suffice since only lane A is used during the transfer of words containing the bytes/chunks for the security key stripe K.

In FIG. 7 data words are being transferred from data source to destination (e.g., eFuse 402 to eFuse Cache 406), with the assumption that data is transferred in consecutive adjacent clock cycles (e.g., FIG. 7). This may be the case if the data source is a static random-access memory (RAM). However, if the source is an eFuse or a dynamic RAM (DRAM), the latency is typically greater than one (1) cycle, and is often variable depending on what else is going on (e.g., DRAM access may be blocked by refresh cycles resulting in a longer than normal latency access time).

For example, between each word transferred there may be a variable number of blank cycles where no data transfer takes place-data is not ready from the source to the destination. Typically, the source provides a signal called “Data-Valid” that when asserted indicates that the data is available to be transferred. Similarly, the data destination may assert a “Ready” when data can be received from the eFuse 402 (data source). This Data-Valid would be asserted at Word0, Word1, . . . , WordN times with blanks without Data-Valid in between. The Key-Stripe K may be the same as shown in FIG. 7, but the data detectors 204 would check the data chunks only when Data-Valid is asserted (1), and the data detector 204 selection (the Detectors column) will advance only when Data-Valid is asserted.

A simple explanation is this, imagine a constant 4 cycle delay (i.e., memory latency) when reading each word, which means there will be 3 blank cycles of Data-Valid=0 between each WordN when Data-Valid=1. Now if the data detectors are changed every cycle (via switch matrix 414) without regard to Data-Valid, then at each valid word transfer, detector selection would always be ABCD (because we had moved through BADC, CDAB, DCBA selections when Data-Valid=0). In this case, even though different detectors are chosen every cycle, if the memory latency in cycles is an integer multiple of the number of lanes, then data detector selection would always come back to ABCD when a valid data word was being transferred. On the other hand, if the order of the data detectors 204 are advanced only when Data-Valid=1, then there would be ABCD for four (4) cycles, BADC for four (4) cycles, CDAB for four (4) cycles, and DCBA for four (4) cycles, then back to ABCD for the next four (4) cycles. Therefore, the data detector 204 selection process will work as intended as shown in FIG. 7A. The Data-Valid signal status, monitored by the data detector controller 412, may be used to control the number of blank cycles where no data transfer takes place—data is not ready from the source and/or the destination is not ready to accept data from the source.

Where “unk” is unknown data or called invalid data or a blank cycle. The chart (table) shown in FIG. 7A would be very similar if data latency is variable. The operational selections and configurations of the data detectors 204 would just depend on the source-driven signal Data-Valid and/or destination Ready signal to determine when to advance the data detector selections and enable the selected data detectors.

Referring to FIG. 8, depicted are representative security key byte maps of a plurality of data byte/chunks, two per word, for two security key stripes, according to an example. Two lanes transfer bytes for two security key stripes. Eight-byte security key stripes K and J may be transferred from the eFuse 402 (data source) to the eFuse cache 406 (data destination) in eight-word transfers and examined for security key programming by all four data detectors 204a-204d. Two security key stripes K and J may be simultaneously assembled from bytes of each of the eight-word transfers and examined for security key programming by four different data detectors 204, two different data detectors 204 operating simultaneously. The security key logic of FIG. 6 is required since lanes A and C are used during the transfer of words containing the bytes/chunks for the security key stripes K and J. It is contemplated and within the scope of this disclosure and what is claimed herein that two to four security key stripes may be programmed from two to four lanes. The number of security key stripes N may be simultaneously programmed from N lanes and checked with N independent data detectors according to the teachings of this disclosure.

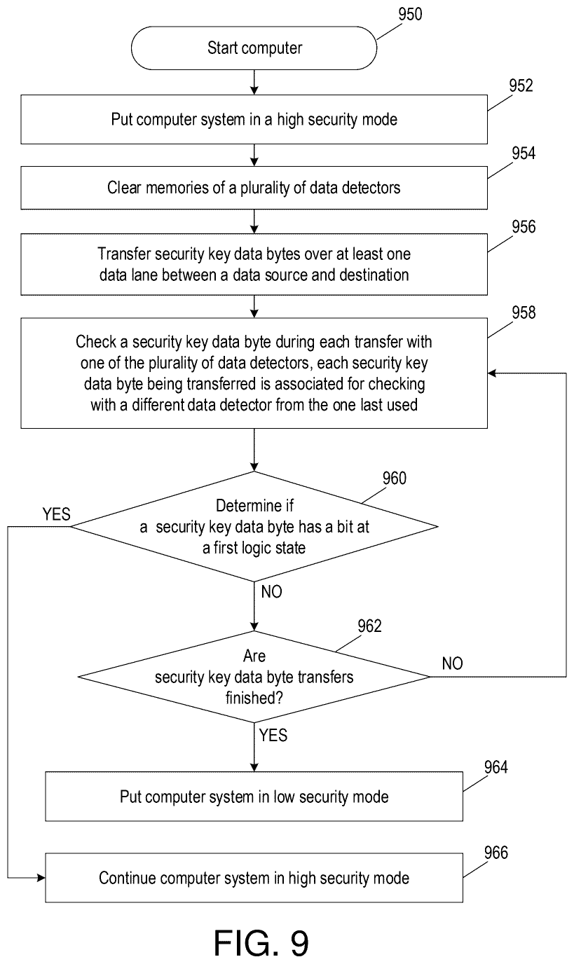

Referring to FIG. 9, depicted is a schematic process flow diagram of a plurality of data detectors checking a plurality of security key data bytes being transferred over at least one data lane of a computer system for a bit having a first logic state indicating a user programmed security key, according to an example. In step 950 a computer system is started, e.g., turned on, boot-up. In step 952, when the computer system is started it is placed into a high security mode. In step 954 all memories of a plurality of data detectors are cleared for use in discovering (detecting) programmed security key data bytes. In step 956 the security key data bytes are transferred from a data source to a data destination over at least one data lane.

In step 958 each security key data byte is checked, during a transfer from the data source to the data destination, for any bit having a first logic state, e.g., a logic “1”, with one of the plurality of data detectors. Each security key data byte being transferred is associated for checking with a different data detector from the one last used. In step 960 the data detector coupled to the security key data byte being transferred determines whether a bit therein is at the first logic state. If YES in step 960, then go to step 966 and the computer system remains in the high security mode. If NO in step 960, then go to step 962 and determine whether the security key data byte transfers are finished. If NO in step 962, then return to step 958 for another security key data byte to be checked, during a next transfer from the data source to the data destination, for any bit having a first logic state, e.g., a logic “1”, with another one of the plurality of data detectors. If YES in step 962, then go to step 964 and put the computer system into a low security mode.

As will be appreciated by one skilled in the art and having the benefit of this disclosure, the embodiments disclosed herein may be embodied as a system, method, apparatus, or computer programmed product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

While the foregoing is directed to embodiments of the present invention, other and further embodiments of the invention may be devised without departing from the basic scope thereof, and the scope thereof is determined by the claims that follow.

What is claimed:

1. A method for detecting logic states of bits in data bytes, comprising:
reading, by a plurality of data detectors, bits of respective data bytes transferred on at least one data lane between a data source and a data destination;
checking the read bits for a first logic state, wherein a bit read from a first data byte is checked with a data detector different from a data detector used to check a bit read from a previously transferred data byte on a same data lane; and
indicating when the first logic state is detected in any of the read bits.

2. The method according to claim 1, wherein
some of the data bytes transferred are security key data bytes, and
the security key data bytes are programmed with a security key when the first logic state is detected in at least one bit thereof.

3. The method according to claim 2, further comprising outputting a high security control signal for putting the computer system into a high security mode before transferring the security key data bytes and reading the at least one bit thereof.

4. The method according to claim 3, further comprising clearing memories of the plurality of data detectors before reading the bits of the security key data bytes.

5. The method according to claim 4, further comprising outputting a low security control signal for putting the computer system into a low security mode when no first logic state is detected on a bit of any of the security key data bytes transferred.

6. The method according to claim 2, further comprising transferring the security key data bytes from the data source to the data destination when available from the data source and the data destination is ready to receive the data bytes from the data source.

7. The method according to claim 1, further comprising associating ones of the plurality of data detectors only with the security key data bytes during transferring thereof.

8. The method according to claim 2, further comprising assembling a security key stripe from the security key data bytes transferred to the data source.

9. The method according to claim 2, further comprising assembling a plurality of security key stripes from the security key data bytes transferred to the data source.

10. The method according to claim 9, further comprising transferring the security key data bytes for each security key stripe on different data lanes between the data source and the data destination.

11. The method according to claim 1, wherein each of the data bytes is 8-bits.

12. An apparatus for detecting logic states of bits in data bytes during transfers thereof, comprising:
a data source adapted for providing a plurality of bytes of data;
a data destination adapted for receiving and storing the plurality of bytes being transferred from the data source over at least one data lane;
a plurality of multiplexers having inputs coupled to the at least one data lane and outputs selectably coupled to the inputs thereof;
a plurality of data detectors having inputs coupled to the outputs of the plurality of multiplexers, wherein the plurality of multiplexers are adapted for coupling the at least one data lane to the inputs of each of the plurality of data detectors;
a spray multiplexer controller coupled to the plurality of multiplexers for controlling which ones of the plurality of data detectors are coupled to the at least one data lane;
a data detector controller coupled to the plurality of data detectors for configuring each of the plurality of data detectors for reading bits of respective bytes being transferred, wherein each of the bytes being transferred is checked with a data detector different from the data detector used to check a previously transferred byte on a same data lane; and
a detected data processor coupled to the outputs of the plurality of data detectors representing bit state status of the bytes being transferred between the data source and the data destination, wherein the detected data processor outputs
a first signal if bits of the byte are detected at expected logic states during transfers of the bytes to the data destination, and
a second signal if a bit of the bytes detected is not at the expected logic states during transfers of the bytes to the data destination.

13. The apparatus according to claim 12, wherein some of the bytes transferred are security key bytes having at least one of the bits at a first logic state.

14. The apparatus according to claim 12, wherein some of the bytes transferred have parity bits therein, and if the logic states of the bits of the byte detected are at the expected logic states then the first signal is outputted and if not then the second signal is outputted.

15. The apparatus according to claim 12, wherein the plurality of multiplexers comprises a switch matrix.

16. The apparatus according to claim 12, wherein the data source is an eFuse memory and the data destination is an eFuse cache.

17. An apparatus for detecting when a security key is programmed in a computer system, comprising:
a data source adapted for providing a plurality of security key bytes comprising at least one security key;
a data destination adapted for receiving and storing the plurality of security key bytes being transferred from the data source over at least one data lane;
a switch matrix having inputs coupled to the at least one data lane and outputs selectably coupled to the inputs thereof;
a plurality of data detectors having inputs coupled to the outputs of the switch matrix, wherein the switch matrix is adapted for coupling the at least one data lane to the inputs of each of the plurality of data detectors;
a switch matrix controller coupled to the switch matrix for controlling which ones of the plurality of data detectors are coupled to the at least one data lane;
a data detector controller coupled to the plurality of data detectors for configuring each of the plurality of data detectors for checking at least one bit of respective security key bytes being transferred for a first logic state, wherein each of the security key bytes being transferred is checked with a data detector different from the data detector used to check a previously transferred security key byte on a same data lane; and
a security processor coupled to the outputs of the plurality of data detectors representing bit state status of the security key bytes being transferred between the data source and the data destination, wherein the security processor outputs
a high security control signal if a bit is detected at the first logic state during transfers of the security key bytes to the data destination, and
a low security control signal when no bit is detected at the first logic state after transfers of the security key bytes to the data destination are finished.

18. The apparatus according to claim 17, wherein:
the high security control signal is adapted to keep the computer system in a high security mode during transfers of the security key bytes to the data destination, and if a bit is detected at the first logic state during transfers thereof, then the computer system will remain in the high security mode; and
the low security control signal is adapted to put the computer system into a low security mode if no bit is detected at the first logic state after transfers of the security key bytes to the data destination are finished.

19. The apparatus according to claim 18, wherein each of the plurality of data detectors comprise a plurality of memories configured to store and retain the first logic state when detected in a bit of a respective security key byte.

20. The apparatus according to claim 19, wherein the inputs of the data detectors will be enabled by the data detector controller when a security key byte is being transferred and disable when a byte being transferred is not a security key byte.
